(19) United States
(12) Patent Application Publication
(10) Pub. No.: US 2025/0005099 A1
(43) Pub. Date: Jan. 2, 2025

(54) CONTEXTUAL BANDIT WITH TRENDING REWARD FUNCTION

(71) Applicant: International Business Machines Corporation, Armonk, NY (US)

(72) Inventor: Djallel Bouneffouf, Poughkeepsie, NY (US)

(21) Appl. No.: 18/343,104

(22) Filed: Jun. 28, 2023

(51) Int. Cl. G06F 17/11

(52) U.S. Cl. CPC G06F 17/11

(57) ABSTRACT

A method for solving a contextual bandit problem having a trending reward function including identifying a contextual bandit (MAB) problem having multiple arms i and a known trend, wherein the shape of a reward function for each of the multiple arms is known, and wherein a distribution of the reward function is unknown and implementing a Linear Upper Confidence Bound Contextual Bandit (ALINUCB) algorithm to take advantage of the shape of the reward function by causing each of the multiple arms to be independently drawn by the agent responsive to a sequence during a predetermined time period, identifying a preferred arm from the multiple arms, wherein the primary arm has the best reward during the predetermined time period, engaging the preferred arm during the predetermined time period, detecting the expiration of the predetermined time period and testing each of the multiple arms for a subsequent predetermined time period.

### BACKGROUND

The present invention generally relates to a contextual bandit solution approach, and more specifically, to a contextual solution approach having a known trend.

Contextual bandit is a machine learning framework that is designed to address and solve complex problems. Contextual bandit allows for a learning algorithm to ‘test’ different actions and learn which action has the most rewarding outcome for a given situation. The basic formulation of a stochastic Contextual bandit (MAB) problem can be simply stated as 1) there are K arms, where each arm has a fixed, unknown and independent probability-law of reward; 2) at each step, a player chooses an arm and receives a reward; and 3) the reward is drawn according to the selected arm's law and it is independent of previous actions. Using this assumption, many policies have been proposed to optimize the long-term accumulated reward.

Unfortunately however, although the current Contextual bandit algorithm (Linear Upper Confidence Bound (LIBUCB) algorithm) is a powerful, generalized approach that is able to solve key business needs in a variety of industries, the current Contextual bandit approach is not robust enough to adequately address a growing demand for the efficient retrieval of formation to accommodate system personalization and anomaly detection.

### SUMMARY

Embodiments of the present invention are directed to a method for solving a contextual bandit problem having a trending reward function. According to an aspect, a computer-implemented method includes identifying a contextual bandit (MAB) problem having multiple arms i and a known trend, wherein the shape of a reward function for each of the multiple arms is known by an agent, and wherein a distribution of the reward function is unknown by the agent, and implementing a Linear Upper Confidence Bound Contextual Bandit (ALINUCB) algorithm to take advantage of the shape of the reward function by causing each of the multiple arms to be independently drawn by the agent responsive to a sequence during a predetermined time period, identifying a preferred arm from the multiple arms, wherein the primary arm has the best reward during the predetermined time period, engaging the preferred arm during the predetermined time period, detecting the expiration of the predetermined time period and testing each of the multiple arms for a subsequent predetermined time period.

Embodiments of the invention are also directed to computer-implemented methods and computer program products having substantially the same features and functionality as the computer system described above.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 shows a block diagram of an example computer system for use in accordance with one or more embodiments of the present invention;

FIG. 2 shows a graph illustrating the results of the method of the invention being used to solve a problem with a decreasing reward function as compared to current methods, in accordance with one or more embodiments of the present invention;

FIG. 3 shows a graph illustrating the results of the method of the invention being used to solve a problem with a Sigmoid reward function as compared to current methods, in accordance with one or more embodiments of the present invention;

FIG. 4 shows a graph illustrating the results of the method of the invention being used to solve a problem with a Gaussian reward function as compared to current methods, in accordance with one or more embodiments of the present invention; and

FIG. 5 is an operational block diagram illustrating a method for solving a contextual bandit problem with a trending reward function, in accordance with one or more embodiments of the present invention.

### DETAILED DESCRIPTION

As discussed briefly above, the current Contextual bandit approach is not robust enough to adequately provide solutions to problems that are constantly evolving due to growing modern demands. For example, LINUCB is not able to adequately address situations that have known trends, such as where the player knows the shape of the reward function for each arm, but not the distribution. These new type of problems are being introduced and are becoming more prevalent due to different on-line issues like active learning and music and interface applications, where when an arm is sampled by the model, the received reward changes according to a known trend. The present invention provides an algorithm (ALINUCB) which assumes a stochastic model which ‘knows’ the shape of the reward function assumption and which provides upper bounds of the regret which compare favorably with the ones used for LINUCB.

In the traditional stochastic Contextual bandit problem, each arm delivers rewards that are independently drawn from an unknown distribution. One solution based on optimism in the face of the uncertainty principle computes an index for each arm and the arm with the highest index is chosen. In this case, the regret (i.e., the cumulative difference between the optimal reward and the expectation of reward) is bounded by a logarithmic function. The present disclosure provides a method which considers where either the set of arms or their expected reward may change over time. This type of approach has several applications, including active learning, music and interface recommendation, where the rewards are far from being stationary random sequences. Specifically, in an embodiment, the method of the present invention may consider and factor that the reward function of each arm can follow any function, not just a decreasing function. Thus, the method of the invention may be applicable to the general model of restless bandits with a known shape of the reward function.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as for solving a contextual bandit problem having a trending reward function 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

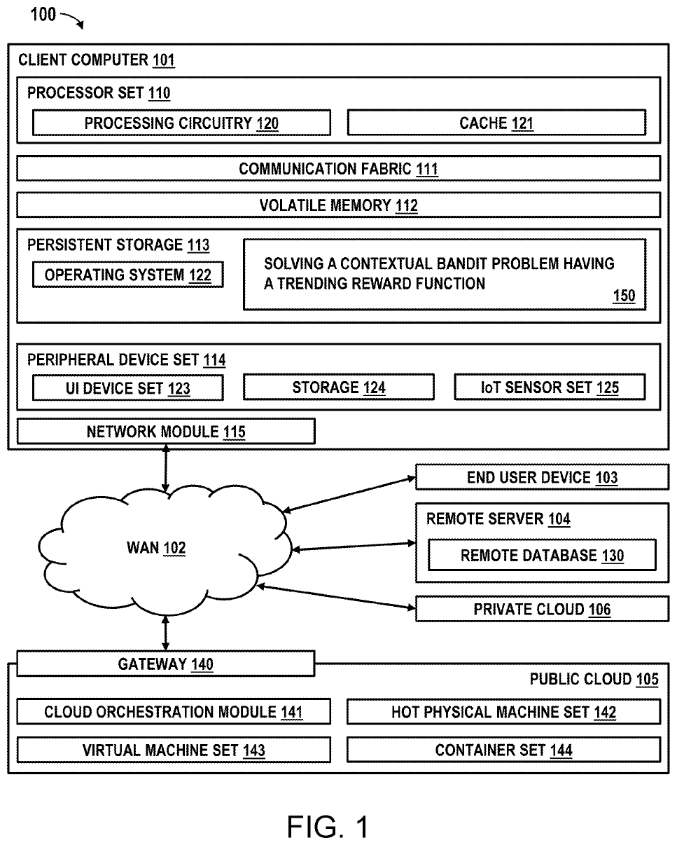

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

One or more embodiments described herein can utilize machine learning techniques to perform tasks. More specifically, one or more embodiments described herein can incorporate and utilize rule-based decision making and artificial intelligence (AI) reasoning to accomplish the various operations described herein, namely containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

In an embodiment, a Contextual bandit algorithm (ALINUCB) which bounds its regret is provided and disclosed. Consider the MAB situation discussed above, where there are K arms each having a fixed, unknown and independent probability-law of reward and, at each step, a player chooses an arm and receives a reward. In this situation the reward is drawn according to the selected arm's law and it is independent of previous actions. In order to maximize the gain, the player has to find the best arm as soon as possible and then exploit it. In this embodiment, the rewards follow a known function. Thus, when the player has found the best arm, the player knows that this arm will be the best arm for only a certain period of time. Thus, the player needs to re-explore at each arm pull to find the next best arm. This setting may be defined by letting rᵢ(1), . . . , rᵢ(n) be a sequence of independent draws of the random variable rᵢ∈[0,1] and let μᵢ=E[rᵢ] be its mean reward. At each time t, the player chooses an arm i∈{1, . . . , K} to play according to a (deterministic or random) policy π based on a sequence of plays and reward, and obtains a non-stationary reward z(t), where z(t)= [symbol] , where [symbol] is a function assumed to be known, [symbol] is the number of times i is played and [symbol] is the stationary reward for arm i at time t.

A dynamic policy may be defined as a function such that (π:t→n₁(t), . . . , n_{K}(t)) or π:Hₜ₋₁→K, where Hₜ₋₁ is the history of rewards known at t. By applying a policy π at a time t, a sequence of choices (1,2, . . . , t)∈[K]^{t} is obtained, where the gain G_{π}(t) of the policy π at time t is given by: G_{π}(t)=Σₜz(t)=Σₜ [symbol] . As such, the performance of a policy π is measured in terms of regret in the first T plays, which may be defined as the expected difference between the total rewards collected by the optimal policy π* (i.e., playing at each time instant the arm i* with the highest expected reward) and the total rewards collected by the policy π.

In an embodiment, the objective is to minimize the regret R(T) at time T, where T is the time horizon. The expected regret after T plays may be expressed as:

$$E [ R ( T ) ] = E [ G * ( T ) ] - E [ G ( T ) ] ,$$

where E[G*T)]=Σᵢ₌₁^{k}μᵢΣₛ₌₁ⁿ^{ᵢ}^{(t)}D(s) is the optimal gain expectation, and E[G(T)]=Σᵢ₌₁^{k}μᵢE [symbol] . is the expected gain obtained by the policy π. In an embodiment, the expectation may be distributed because rᵢ(t) and nᵢ(t) are independent. Moreover, in an embodiment, the optimal policy in any time π* may include playing the arm i∈{1, . . . , K} with the largest expected reward i*=argmaxᵢ[μᵢ·D(nᵢ(t))], where μᵢ is the expectation of the reward rᵢ(t)). Additionally, F is the cumulative function of D(s) and may be expressed as F(nᵢ(T))=Σ_{s=T}ⁿ^{ᵢ}^{(T)}D(s) and may be assumed to be the Lipschitz bandit.

In an embodiment, the ALINUCB algorithm of the present invention computes at each trial t an index I(i)=(\hat{μ}ᵢ+c(i))·D(nᵢ(t)) for each arm i, where c(i) is the corresponding confidence interval, so that

$$c ( i ) = \sqrt{\frac{2 \times log ( t )}{{n}_{i} ( t )}} .$$

The LINUCB index is multiplied by D(nᵢ(t)) to stop playing the supposed optimal arm when its reward becomes suboptimal. Given the above, the ALINUCB algorithm may be expressed as:

Algorithm 1: The ALINUCB algorithm

Require: Arm i ∈ I.
Foreach t = 1, 2, . . . ,T do
Select arm iₜ = argmaxᵢI(i) and observe reward rᵢ(t).
End

where for a bandit problem having a known trend, the accumulated expected regret R of ALINUCB policy may be bounded by

$$E [ R ( T ) ] \leq {max}_{i} {μ}_{i} {D}_{max} {\sum }_{\text{?} {n}_{\text{?}}^{\text{?}} ( T ) > {n}_{i} ( T )} \frac{8 ln T}{{Δ}_{\text{?}}^{{\text{?}}_{2}}} + K \frac{{π}^{2}}{3} .$$

$$\text{?} \text{indicates text missing or illegible when filed}$$

It should be appreciated that the method of the invention was achieved by applying an upper bounding limit to E[R(T)] by maxᵢμᵢDₘₐₓ. This gives the true statements [symbol] and [symbol] . Applying the Chernoff-Hoeffding bound, Xᵢ∈[0,1] was determined to be independent random variables with μ=E[Xᵢ]. Given this, it was determined that

$$Pr ( \frac{1}{{n}_{\text{?}} ( t )} {\sum }_{i = 1}^{{n}_{\text{?}} ( t )} {X}_{i} - μ \geq \text{?} ) \leq {e}^{- 2 {n}_{\text{?}} ( t ) {\text{?}}^{2}} , and Pr ( \frac{1}{{n}_{\text{?}} ( t )} {\sum }_{i = 1}^{{n}_{\text{?}} ( t )} {X}_{i} - μ \geq \text{?} ) \leq {e}^{- 2 {n}_{\text{?}} ( t ) {ϵ}^{2}} .$$

$$\text{?} \text{indicates text missing or illegible when filed}$$

Next, applying the L-lipschitz function and letting M, a part from R, f: M→R, be a function and L a real positive, then it is known that ∀(x,y)∈M², |f(x)−f(y)|≤L|x−y| is true. It can then be shown that E[R(T)]≤maxᵢμᵢDₘₐₓ [symbol] is a true statement by recognizing that E[R(T)]=E[G*(T)]−G[G(T)]⇒E[R(T)]=Σᵢ₌₁^{k}μᵢΣ [symbol] where F is monotonous. The following is true, [symbol] [symbol] [symbol] , where F is an increasing function. Additionally, [symbol] [symbol] , and [symbol] because there is no regret when nᵢ(T)≤ [symbol] , and [symbol] . With F being Dₘₐₓ−Lipschitz, then [symbol] , where Dₘₐₓ=maxₛD(s) and s∈[1,T]. Therefore, [symbol] and [symbol] . At this point, [symbol] is bounded and is equal to [symbol] .

Next, it is known that

$${\sum }_{t = 1}^{T} Pr ( i ( t ) - i ) 1 \{ {n}_{i} ( t ) \geq {n}_{i}^{*} ( t ) ) \leq \frac{8 log T}{{{Δ}_{\text{?}}^{\text{?}}}^{2}} + \frac{{π}^{2}}{3}$$

$$\text{?} \text{indicates text missing or illegible when filed}$$

is true. This can be seen by letting

$$B ( i ) = {\hat{μ}}_{{i}_{\text{?}}} + \sqrt{\frac{2 log t}{{n}_{{i}_{\text{?}}} ( t )}} ,$$

$$\text{?} \text{indicates text missing or illegible when filed}$$

and from hoeffding it is known that with 1≤nᵢ_{ₜ}(t)≤t,

$$Pr ( {\hat{μ}}_{{i}_{\text{?}}} + B ( i ) \leq {μ}_{{i}_{\text{?}}} ) \leq {e}^{- 4 log ( t )} = {t}^{- 4} \qquad ( 1 )$$

$$\text{?} \text{indicates text missing or illegible when filed}$$

and

$$Pr ( {\hat{μ}}_{{i}_{\text{?}}} - B ( i ) \leq {μ}_{{i}_{\text{?}}} ) \leq {e}^{- 4 log ( t )} = {t}^{- 4} \qquad ( 2 )$$

$$\text{?} \text{indicates text missing or illegible when filed}$$

are true. Assuming that at the time t the empiric mean of each arm is in its confidence interval, then

$$D ( {n}_{{i}_{\text{?}}} ( t ) ) \cdot ( {μ}_{{i}_{\text{?}}} - B ( i ) ) {\leq }^{( a )} D ( {n}_{{i}_{\text{?}}} ( t ) ) \cdot ( {\hat{μ}}_{{i}_{\text{?}}} {\leq }^{( b )} D ( {n}_{{i}_{\text{?}}} ( t ) ) \cdot ( {μ}_{{i}_{\text{?}}} + B ( i ) ) \qquad ( 3 )$$

$$\text{?} \text{indicates text missing or illegible when filed}$$

is true. Letting iₜ be a suboptimal arm and iₜ^{*} be an optimal arm. If the arm iₜ is play at the time t, then

$$D ( {n}_{{i}_{\text{?}}} ( t ) ) ) \cdot ( {{μ}^{\text{?}}}_{{i}_{\text{?}}} + \sqrt{\frac{2 log t}{{n}_{{i}_{\text{?}}} ( t )} )} \geq D ( {n}_{{i}_{\text{?}}^{\text{?}}} ( t ) ) ) \cdot ( {{μ}^{\text{?}}}_{{i}_{\text{?}}^{\text{?}}} + \sqrt{\frac{2 log t}{{n}_{{i}_{\text{?}}^{\text{?}}} ( t )}} \geq D ( {n}_{{i}_{\text{?}}^{\text{?}}} ( t ) ) ) \cdot {μ}_{{i}_{\text{?}}^{\text{?}}} .$$

$$\text{?} \text{indicates text missing or illegible when filed}$$

From equation (3) then,

$$D ( {n}_{{i}_{\text{?}}} ( t ) ) ) \cdot ( {{μ}^{\text{?}}}_{{i}_{\text{?}}} + \sqrt{\frac{2 log t}{{n}_{{i}_{\text{?}}} ( t )} )} \geq D ( {n}_{{i}_{\text{?}}^{\text{?}}} ( t ) ) ) \cdot \sqrt{\frac{2 log t}{{n}_{{i}_{\text{?}}^{\text{?}}} ( t )}} \geq D ( {n}_{{i}_{\text{?}}^{\text{?}}} ( t ) ) ) \cdot {μ}_{{i}_{\text{?}}^{\text{?}}} ,$$

$$D ( {n}_{{i}_{\text{?}}} ( t ) ) ) \cdot ( {{μ}^{\text{?}}}_{{i}_{\text{?}}} + \sqrt{\frac{2 log t}{{n}_{{i}_{\text{?}}} ( t )} )} \geq D ( {n}_{{i}_{\text{?}}^{\text{?}}} ( t ) ) ) \cdot {μ}_{{i}_{\text{?}}^{\text{?}}} ,$$

$$2 \sqrt{\frac{2 log t}{{n}_{{i}_{\text{?}}} ( t )}} D ( {n}_{{i}_{\text{?}}} ( t ) ) ) \geq D ( {n}_{{i}_{\text{?}}^{\text{?}}} ( t ) ) ) \cdot {μ}_{{i}_{\text{?}}^{\text{?}}} - D ( {n}_{{i}_{\text{?}}^{\text{?}}} ( t ) ) ) \cdot {μ}_{{i}_{\text{?}}^{\text{?}}} ,$$

$$2 \sqrt{\frac{2 log t}{{n}_{{i}_{\text{?}}} ( t )}} \geq \frac{D ( {n}_{{i}_{\text{?}}^{\text{?}}} ( t ) ) )}{D ( {n}_{{i}_{\text{?}}} ( t ) ) )} \cdot {μ}_{{i}_{\text{?}}^{\text{?}}} - \cdot {μ}_{{i}_{\text{?}} ,}$$

$$\text{?} \text{indicates text missing or illegible when filed}$$

and with Dₘᵢₙ≤D(nᵢ_{ₜ}(t))≤Dₘₐₓ and

$${Δ}_{i}^{\text{?}} = \frac{{D}_{min}}{{D}_{max}} {μ}_{{i}_{\text{?}}^{*}} - {μ}_{{i}_{t}} , then \sqrt{\frac{2 log t}{{n}_{{i}_{\text{?}}} ( t )}} \geq {{Δ}_{i}^{\text{?}}}^{2}$$

$$\text{?} \text{indicates text missing or illegible when filed}$$

means that

$${{n}_{i}}_{t} ( t ) \leq \frac{8 log t}{{{Δ}_{\text{?}}^{\text{?}}}^{2}} .$$

$$\text{?} \text{indicates text missing or illegible when filed}$$

Accordingly, for all integers u, the following is true:

$${n}_{{i}_{\text{?}}} ( t ) \leq u + {\sum }_{t = u + 1}^{T} 1 \{ {I}_{t} = {i}_{t} : {n}_{{i}_{\text{?}}} ( t ) > n \} \leq u + {\sum }_{t = u + 1}^{T} 1 \{ ∃ {n}_{{i}_{\text{?}}} ( t ) : u < {n}_{{i}_{\text{?}}} ( t ) \leq t , ∃ {n}_{{i}_{\text{?}}^{\text{?}}} ( t ) : 1 \leq {n}_{{i}_{\text{?}}^{\text{?}}} ( t ) \leq t , {B}_{t , {n}_{\text{?}} ( t )} ( {i}_{t} ) \geq {B}_{t , {n}_{\text{?}} ( t )} ( {i}_{\text{?}}^{\text{?}} ) \} . \qquad ( 4 )$$

$$\text{?} \text{indicates text missing or illegible when filed}$$

Referring to equation (4), it is known that equation (3)

$$⇒ {n}_{{i}_{t}} ( t ) < \frac{8 log t}{{Δ}^{2} {i}_{\text{?}}}$$

$$\text{?} \text{indicates text missing or illegible when filed}$$

or the inequality (a) or (b) in equation (3) is not satisfied. Then by choosing,

$$u = \frac{8 log t}{{Δ}_{\text{?}}^{2}}$$

$$\text{?} \text{indicates text missing or illegible when filed}$$

it can be inferred that (a) or (b is not satisfied. However, from equation (1), the inequality (a) is not satisfied with a probability ≤t⁻⁴, and from equation (2) the inequality (b) is not satisfied with a probability ≤t⁻⁴. By taking the arithmetic mean in both sides of equation (4), the following is true:

$$E [ {n}_{{i}_{\text{?}}} ( t ) ] \leq \frac{8 log t}{{Δ}_{i}^{′2}} + {\sum }_{t = u + 1}^{T} {\sum }_{s = u + 1}^{t} {t}^{- 4} {\sum }_{s = 1}^{t} {t}^{- 4}$$

$$E [ {{n}_{i}}_{\text{?}} ( t ) ] \leq \frac{8 log t}{{Δ}_{i}^{′2}} + \frac{{π}^{2}}{3}$$

$${\sum }_{t = 1}^{T} Pr ( i ( t ) = i ) 1 \{ {n}_{i} ( t ) \geq {n}_{i}^{*} ( t ) \} \leq \frac{8 log t}{{Δ}_{i}^{′2}} + \frac{{π}^{2}}{3} .$$

$$\text{?} \text{indicates text missing or illegible when filed}$$

Accordingly,

$${\sum }_{i \text{?} {n}_{\text{?}}^{\text{?}} ( T ) > {n}_{\text{?}} ( T )} {\sum }_{t = 1}^{T} Pr ( i ( t ) = i ) 1 \{ {n}_{i} ( t ) \geq {n}_{i}^{\text{?}} ( t ) \} \leq {\sum }_{i : {n}_{i}^{\text{?}} ( T ) > {n}_{\text{?}} ( T )} \frac{8 ln t}{{Δ}_{i}^{′2}} + K \frac{{π}^{2}}{3} , where k = \vert i \vert : {n}_{i}^{*} ( T ) > {n}_{i} ( T ) , with$$

$${\sum }_{i \text{?} {n}_{\text{?}}^{\text{?}} ( T ) > {n}_{\text{?}} ( T )} {\sum }_{t = 1}^{T} Pr ( i ( t ) = i ) 1 \{ {n}_{i} ( t ) \geq {n}_{i}^{\text{?}} ( t ) \} = {\sum }_{i : {n}_{i}^{\text{?}} ( T ) > {n}_{\text{?}} ( T )} \vert {n}_{i}^{*} ( T ) - E [ {n}_{i} ( T ) ] \vert$$

$$E [ R ( T ) ] \leq {max}_{i} {μ}_{i} {D}_{max} {\sum }_{i : {n}_{\text{?}}^{\text{?}} ( T ) > {n}_{i} ( T )} \frac{8 ln t}{{Δ}_{i}^{′2}} + K \frac{{π}^{2}}{3} .$$

$$\text{?} \text{indicates text missing or illegible when filed}$$

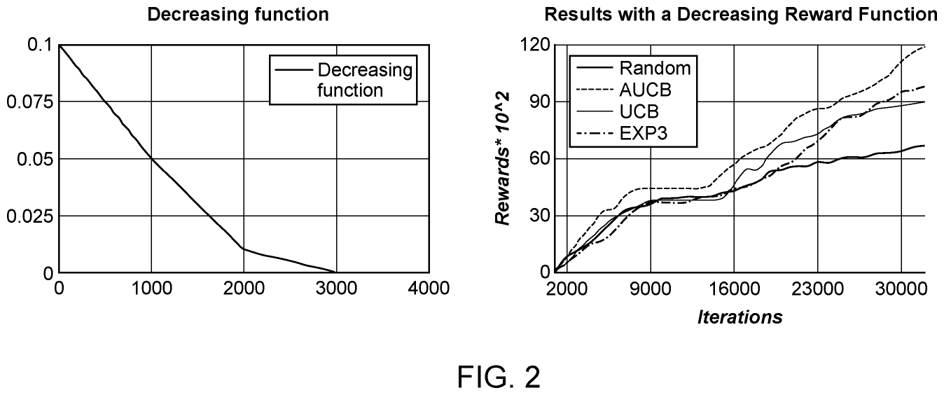

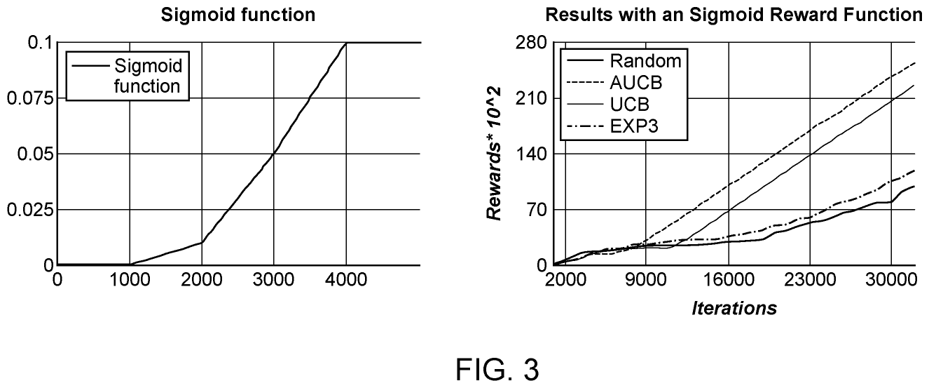

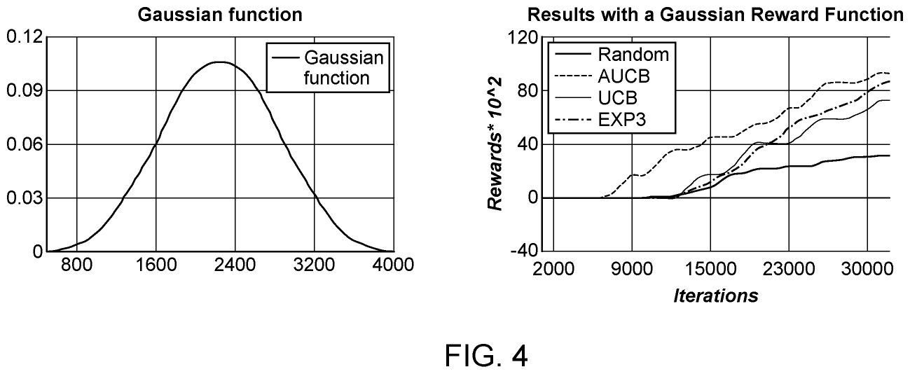

The above has been tested to illustrate the strengths and weaknesses of the method of the present invention as comparison to the current methods. Accordingly, three synthetic known trend bandit problems were formulated having three reward functions: decreasing reward function (FIG. 2), sigmoid reward function (FIG. 3) and Gaussian reward function (FIG. 4). In these problems, there were eight (8) arms used and the mean reward was fixed as follows: μ₁=0.6, μ₂=0.4 μ₃=0.3 μ₄=0.3 μ₅=0.15 μ₆=0.1 μ₇=0.05 μ₈=0.05, where D(n)∈[0,4000], D(n)=6.65 ln (n)+9.57 for FIG. 1, D(n)=0.037exp(1.15n) for FIG. 2, and D(n)=0.037exp(1.15n) for FIG. 3, where D(n)=exp(−(n−20)²/40). It was found that in this simulation, at each round, if the algorithm chooses the right arm, the reward is 1 or else 0. The accumulated rewards are computed each 1000 reiterations. The plot of the curves were produced by averaging 20 runs of each algorithm and running the simulation was run until 32,000 iterations were conducted as shown in FIG. 2, FIG. 3 and FIG. 4.

Referring to FIG. 2, the first problem shows a decreasing reward function, where this kind of model can be seen in different real world problems involving recommendation systems like music or ad recommendation. In an embodiment, with this type of problem, the method of the invention (ALINUCB) quick outperforms the current algorithms, which may be due to the fact that at each iteration the algorithm is aware about the reward function of each arm thereby allowing it to find the optimal arms at the optimal time. It was also observed that a non-stationary strategy like EXP3 may be better than a stationary one (UCB), which confirms that the bandits based on a stationary assumption can not solve a non-stationary problem as they typically perform near the same as a random choice of actions.

Referring to FIG. 3, another embodiment is shown with regards to a sigmoid reward function, wherein this kind of problem can be seen in different real world problems of recommendation systems like interface recommendation. With this problem, the method of the invention (ALINUCB) still outperforms other algorithms, but it performance may be explained, at least in part, by the rapidity of the ALINUCB to find the greatest tradeoff between arms. It was found that UCB outperforms EXP3 after 11,000 iterations where the rewards become more stationary. Referring to FIG. 4, still yet another embodiment is shown with regards to a gaussian reward function which may model the reward function of games or clothes recommendation. In this model it was found that at the increasing part of the rewards function, from 0 to 20,000 iterations, UCB outperform EXP3 but after 20,000 iterations, EXP3 takes over which may be explained by the difficulty of UCB to change the confidence in an arm.

It should be appreciated that the present disclosure provides a new formulation of the MAB problem motivated by real world problems involving active learning, music and interface recommendation. In these settings, the set of strategies available to a MAB algorithm may change rapidly over time. The present invention provides an extension which allows a UCB algorithm to be used in the case of a MAB problem having a known trend.

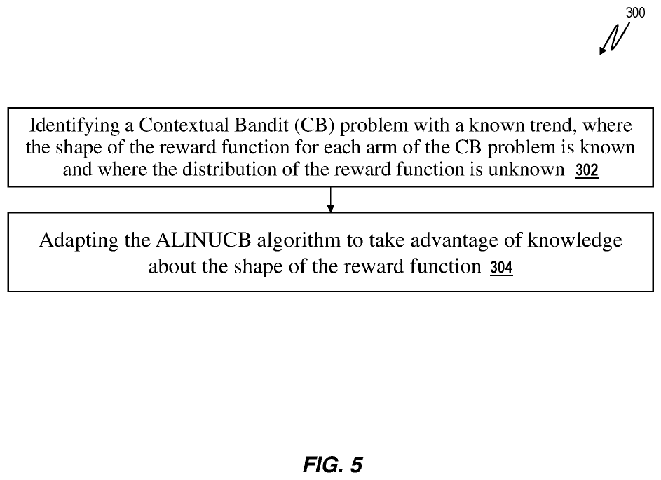

Referring to FIG. 5, a method 300 for solving a contextual bandit problem with a trending reward function is provided, in accordance with an embodiment of the invention. The method 300 includes identifying a Contextual Bandit (CB) problem with a known trend, where the shape of the reward function for each arm of the CB problem is known and where the distribution of the reward function is unknown, as shown in operational block 302. The method 300 further includes adapting the LINUCB algorithm to take advantage of knowledge about the shape of the reward function, as shown in operational block 304. This may be accomplished by causing an agent to independently draw each arm in a predetermined sequence during a predetermined time period, identifying one arm that has the best reward during the time period, playing this arm during the time period, detecting the expiration of the time period and testing each arm for the subsequent time period. It should be appreciated that the adapted LINUCB may include an arm chosen at each time t according to a policy μ based on a sequence of play and reward which obtains a non-stationary reward z(t) where z(t)=rᵢ(t)·D(nᵢ(t)), wherein rᵢ(1) . . . rᵢ(n) is the sequence of independent draws of a random variable rᵢ∈[0, 1], n is the number of trials, μᵢ=E[rᵢ] is the mean reward, nᵢ(t) is the number of times i played, D(nᵢ(t)) is the trend reward function and rᵢ(t) is the stationary reward for arm i at a time t.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein. Moreover, the embodiments or parts of the embodiments may be combined in whole or in part without departing from the scope of the invention.

What is claimed is:

1. A method for solving a contextual bandit problem having a trending reward function, the method comprising:
identifying a contextual bandit (MAB) problem having multiple arms and a known trend,
wherein the shape of a reward function for each of the multiple arms is known by
an agent, and
wherein a distribution of the reward function is unknown by the agent; and
implementing a Linear Upper Confidence Bound Contextual Bandit (ALINUCB) algorithm to take advantage of the shape of the reward function by:
causing each of the multiple arms to be independently drawn by the agent responsive to a sequence during a predetermined time period;
identifying a preferred arm from the multiple arms, wherein the primary arm has the best reward during the predetermined time period;
engaging the preferred arm during the predetermined time period;
detecting the expiration of the predetermined time period; and
testing each of the multiple arms for a subsequent predetermined time period.

2. The method of claim 1, wherein identifying the MAB problem includes the agent selecting the MAB problem, where each of the multiple arms includes a fixed, unknown and independent probability-law of reward.

3. The method of claim 2, wherein implementing the ALINUCB algorithm includes the agent selecting an arm from the multiple arms at each step and receiving a non-stationary reward responsive to selecting an arm.

4. The method of claim 3, wherein the reward is responsive to a number of times the arm is engaged by the agent and to a known stationary reward for the arm at a given time.

5. The method of claim 1, wherein implementing includes defining a dynamic policy which is responsive to a history of rewards known at a given time.

6. The method of claim 5, wherein implementing includes applying the policy at a predetermined time to obtain a sequence of choices, wherein the policy includes a Gain.

7. The method of claim 6, wherein implementing includes measuring the policy relative to a predetermined number of plays and an expected regret at the predetermined time, wherein the predetermined time is a time horizon and an expected regret after the predetermined number of plays is responsive to an optimal gain expectation and an expected gain obtained by the policy.

8. The method of claim 1, wherein implementing further includes computing an index for each of a plurality of trial plays for each of the multiple arms, wherein the index for each arm of the multiple arms is responsive to a corresponding confidence interval.

9. The method of claim 8, wherein the ALINUCB algorithm includes, selecting an arm from the multiple arms;
applying an Argmax function to the arm for each of a plurality of predetermined times; and
observing a reward for the arm for each of the predetermined times.

10. The method of claim 9, wherein the ALINUCB algorithm is bounded by an upper bounding limit.

11. A computing system, comprising:
a machine learning system for implementing a method for solving a contextual bandit problem having a trending reward function, the system configured to:
identify a contextual bandit (MAB) problem having multiple arms and a known trend,
wherein the shape of a reward function for each of the multiple arms is known by
an agent, and
wherein a distribution of the reward function is unknown by the agent; and
implement a Linear Upper Confidence Bound Contextual Bandit (ALINUCB) algorithm to take advantage of the shape of the reward function to:
cause each of the multiple arms to be independently drawn by the agent responsive to a sequence during a predetermined time period;
identify a preferred arm from the multiple arms, wherein the primary arm has the best reward during the predetermined time period;
engage the preferred arm during the predetermined time period;
detect the expiration of the predetermined time period; and
test each of the multiple arms for a subsequent predetermined time period.

12. The method of claim 11, wherein identifying the MAB problem includes the agent selecting the MAB problem, where each of the multiple arms includes a fixed, unknown and independent probability-law of reward.

13. The method of claim 12, wherein implementing the ALINUCB algorithm includes the agent selecting an arm from the multiple arms at each step and receiving a non-stationary reward responsive to selecting an arm.

14. The method of claim 13, wherein the reward is responsive to a number of times the arm is engaged by the agent and to a known stationary reward for the arm at a given time.

15. The method of claim 11, wherein implementing includes defining a dynamic policy which is responsive to a history of rewards known at a given time.

16. The method of claim 15, wherein implementing includes applying the policy at a predetermined time to obtain a sequence of choices, wherein the policy includes a Gain.

17. The method of claim 16, wherein implementing includes measuring the policy relative to a predetermined number of plays and an expected regret at the predetermined time, wherein the predetermined time is a time horizon and an expected regret after the predetermined number of plays is responsive to an optimal gain expectation and an expected gain obtained by the policy.

18. The method of claim 1, wherein implementing further includes computing an index for each of a plurality of trial plays for each of the multiple arms, wherein the index for each arm of the multiple arms is responsive to a corresponding confidence interval.

19. The method of claim 8, wherein the ALINUCB algorithm includes, selecting an arm from the multiple arms;
applying an Argmax function to the arm for each of a plurality of predetermined times; and
observing a reward for the arm for each of the predetermined times.

20. A computer program product comprising a computer readable storage medium having program instructions embodied therewith, the program instructions executable by a processor to cause the processor to perform operations comprising:
identifying a contextual bandit (MAB) problem having multiple arms and a known trend,
wherein the shape of a reward function for each of the multiple arms is known by
an agent, and
wherein a distribution of the reward function is unknown by the agent; and
implementing a Linear Upper Confidence Bound Contextual Bandit (ALINUCB) algorithm to take advantage of the shape of the reward function by:
causing each of the multiple arms to be independently drawn by the agent responsive to a sequence during a predetermined time period;
identifying a preferred arm from the multiple arms, wherein the primary arm has the best reward during the predetermined time period;
engaging the preferred arm during the predetermined time period;
detecting the expiration of the predetermined time period; and
testing each of the multiple arms for a subsequent predetermined time period.
